(19) United States
(12) Patent Application Publication
(10) Pub. No.: US 2017/0228631 A1
(43) Pub. Date: Aug. 10, 2017

(54) SMARTCARD AND METHOD FOR CONTROLLING A SMARTCARD

(71) Applicant: Zwipe AS, Oslo (NO)

(72) Inventors: Steffen Larsen, Oslo (NO); Kim Kristian Humborstad, Oslo (NO)

(21) Appl. No.: 15/426,687

(22) Filed: Feb. 7, 2017

(30) Foreign Application Priority Data
Feb. 10, 2016 (GB) 1602371.5

(51) Int. Cl. G06K 19/073; G06K 19/07

(52) U.S. Cl. CPC G06K 19/07354; G06K 19/0723

(57) ABSTRACT

A smartcard having multiple operating modes. The smartcard may include a processor for controlling operation of the smartcard and an accelerometer for sensing movements of the smartcard, wherein the processor is arranged to switch between different modes of the multiple operating modes in response to the movements sensed by the accelerometer.

### TECHNICAL FIELD

The present invention relates to a smartcard having multiple operating modes, and to a method for controlling a smartcard.

### BACKGROUND OF THE INVENTION

Smartcards are becoming increasingly more widely used and include, for example access cards, credit cards, debit cards, pre-pay cards, loyalty cards, identity cards, cryptographic cards, and so on. Smartcards are electronic cards with the ability to store data and to interact with the user and/or with outside devices, for example via contactless technologies such as RFID. These cards can interact with readers to communicate information in order to enable access, to authorise transactions and so on.

In general smartcards have a single purpose, and a single mode of operation, which may be for interaction with a payment device, or an access control device, but not both. They also typically have relatively few features, and often they cannot interact directly with the user, but only with dedicated payment devices and other card readers. Systems exist that allow for payment via multiple payment devices and in different circumstances, such as the use of contactless credit and debit cards for the London Underground “Oyster” payment system. However, little work has been done in connection with adding additional functionality and complexity to smartcards.

### SUMMARY OF THE INVENTION

Viewed from a first aspect the present invention provides a smartcard having multiple operating modes, the smartcard comprising a processor for controlling operation of the smartcard and an accelerometer for sensing movements of the smartcard, wherein the processor is arranged to switch between different modes of the multiple operating modes in response to the movements sensed by the accelerometer.

This smartcard provides additional functionality by allowing interaction between the user and the smartcard using movements or gestures by a user holding or touching the card. This can allow for alternative card features to be activated without the need for manipulation of input devices on the card such as buttons or other sensors needing direct physical contact. Advantageously the smartcard is a contactless card and thus the user can switch between different modes as well as using the card via card readers with the only contact being holding of the card by the user. This can allow for increased features and increased complexity in how the smartcard is used, without detriment to the ease of operation of the card.

The movements sensed by the accelerometer may include rotation of the smartcard in one or more directions (clockwise/anticlockwise) and/or in one or more than one axis of rotation, translation of the smartcard in one or more directions (forward/backward) and along one or more axis, and/or accelerations in one or more directions (forward/backward) and along one or more axis as well as jerk or impulses in one or more directions (forward/backward) and along one or more axis. Combinations of these movements may also be detected, for example a “flick” motion including a combination of translation and acceleration/deceleration to characterise the movement detected by the accelerometer. The axes referenced above may for example be x, y, z axes aligned with the long side of the card, the short side of the card, and the normal to the card.

Rotations of the smartcard sensed by the accelerometer may include changes in orientation of the smartcard, for example switching from portrait to landscape orientation or turning the card over. The rotations may include 90 degree turns, 180 degree turns, 270 degree turns or 360 degree turns, or intervening values, in any direction.

Translational movements may include waving motions, optionally in combination with acceleration/deceleration as with a flicking type motion, or a tapping motion.

The accelerometer may also be arranged to detect a free fall movement, for example when the card is dropped. The use of accelerometers to detect free fall is well-established and is used, for example, to activate safety features of hard disk drives to prevent damage when they are dropped.

The processor may be arranged to identify the movements of the card based on the output of the accelerometer, and to change the operating mode of the smartcard in response to pre-set movements. The pre-set movements may include any or all movements discussed above. In addition, the processor may determine the length of a time period without motion, i.e. a time period indicative of no active usage of the smartcard, and this may also be used to change the operating mode of the smartcard. The processor may also be arranged to identify repeated movements or sequences of movements, such as a double tap, or a translational movement followed by a rotation such as a sliding and twisting motion. Advantageously, the smartcard may be arranged to allow the user to set their own movements and or combinations of movements. For example the processor may have a learn mode where a combination of movements by the user can be taught to the processor and then allocated to a specific change in the operating mode of the smartcard. This can provide for increased security by the use of movements that may be unique to each individual.

The operating modes of the smartcard that are controlled by movements sensed by the accelerometer may be related to a high level function, for example turning the card on or off, activating secure aspects of the card such as contactless payment, or changing the basic functionality of the card for example by switching between operating as an access card, a payment card, a transportation smartcard, switching between different accounts of the same type (e.g. two bank accounts) and so on.

Alternatively or additionally the operating modes of the smartcard that are controlled by movements sensed by the accelerometer may concern more specific functionalities of the smartcard, for example switching between communications protocols (such as blue tooth, wifi, NFC) and/or activating a communication protocol, activating a display such as an LCD or LED display or obtaining an output from the smartcard, such as a one-time-password or the like.

Alternatively or additionally the operating modes of the smartcard that are controlled by movements sensed by the accelerometer may include prompting the card to automatically perform a standard operation of the smartcard. Examples of such standard operations might include a pre-set cash withdrawal in response to a specific movement during or prior to communication with an ATM, entering into a learning or set-up mode, PIN activation of the card (i.e. movements used in place of a PIN entry via a keypad), sending a message to a card reader or a smartphone and so on.

The processor may be arranged to allow for the user to specify which movements (including combinations of movements) should activate particular operating modes. The processor may use different movements for each one of a set of operating modes, or alternatively it may cycle through the operating modes of a set of operating modes in response to a repeated movement.

Examples of combinations of movements and changes in the operating mode of the smartcard include: flicking the card to switch the card application between, for example, access card, payment card, transport system card, turning on the card via a pre-set (preferably user specified) activation gesture, turning the card 180 degrees to switch between blue tooth and NFC, double tap on a surface to activate a display and so on.

One example includes placing the smartcard into a dropped card mode when free fall is detected. This mode may require reauthorisation via a security feature after the card has been picked up before further use of the card is permitted, or before full use of the card is permitted. This can ensure that a dropped card cannot be fraudulently used if found by an unauthorised user. The security feature may include use of a PIN at a card reader (i.e. for a payment card there might be no authorisation for an automatic transaction via contactless payments until PIN authorisation), a combination of movements acting as a PIN, and/or authorisation via other security features on the smartcard itself such as biometric authorisation as discussed below.

The smartcard may enter a dormant/off mode and require re-activation or re-authorisation for continued use after it has been left unused for a period of time, for example for several days or several weeks depending on the application. A re-activation may require a specific sequence of movements to be detected, or activation via interaction with a reader. A reauthorisation may be as discussed above in relation to the dropped card mode.

Although movements can be detected by an accelerometer with a single sensing axis, it is preferred to be able to detect accelerations in all directions. This may be done via multiple accelerometers, but preferably a single accelerometer is used that can detect acceleration in all directions, such as a tri-axis accelerometer.

The accelerometer is preferably a micro-machined accelerometer such as a MEMS accelerometer. The use of these types of devices allows for them to be installed on a smartcard without the need for increasing the size of the smartcard. They also have low power consumption, which can be another design restriction for smartcards. The accelerometer may use a sense element such as a micro-machined cantilever or seismic mass. In an example implementation the acceleration sensing is based on the principle of a differential capacitance arising from acceleration-induced motion of the sense element. A possible accelerometer that could be used is a Tri-axis Digital Accelerometer such as those provided by Kionix, Inc. of Ithaca, N.Y., USA. An example embodiment uses the Kionix KXCJB-1041 accelerometer.

The smartcard may be capable of wireless communication, such as using RFID or NFC communication. Alternatively or additionally the smartcard may comprise a contact connection, for example via a contact pad or the like such as those used for “chip and pin” cards. In various embodiments, the smartcard may permit both wireless communication and contact communication.

The smartcard may comprise a biometric sensor, which is preferably embedded into the card. The biometric sensor may be any suitable sensor for identifying a user via biometric information. One example is an EKG sensor. Another possibility is a fingerprint sensor. With this feature the authorised user may initially enroll their fingerprint onto the actual card, and may then be required to place their finger or thumb on the fingerprint sensor in order to authorise some or all uses of the card. A fingerprint matching algorithm on the processor may be used to identify a fingerprint match between an enrolled user and a fingerprint sensed by the fingerprint sensor.

A biometric sensor may be used to activate subsequent control of the card by movements, or to activate features denoted as higher security, such as a payment or withdrawal with a payment/bank card, or access to more secure areas when the smartcard is an access card. A biometric authorisation may be required in addition to a movement of the card in order to complete a more secure operation.

In some cases a biometric authorisation may fail or may not be possible. For example in the case of a fingerprint sensor the user's fingerprints may be damaged by injury, or covered up. The sensor may also be damaged or might otherwise be inoperable. In this case the smartcard may advantageously allow for a pre-set, and preferably complex, movement acting as a back-up for biometric authorisation. The complex movement may be a motion sequence that includes two or more movements, for example three, four or five movements such as rotations, translations and so on. Preferably the pre-set movement is user defined and hence may be unique to the user.

A situation that can arise with some forms of biometric sensors and fingerprint sensors in particular is a failure to enroll. This is a fundamental issue with a small percentage of the population, who have fingerprints or other biometric characteristics that for some reason cannot be registered using the known biometric sensors. For fingerprints such failures are usually caused by missing or weak characteristics, such as missing fingers, faint fingerprints as well as damaged fingers. A system providing an alternative to biometric enrolment would also allow the use of biometric cards by those users who would just rather not have their biometric details recorded. The movement sensed by the accelerometer can be used as a non-biometric alternative for a biometric card so that people can still access the system or service without using the biometric system. In this case, a smartcard including a biometric sensor as well as the accelerometer may be provided with the ability to enroll via movements sensed by the accelerometer as an alternative to biometric data. The user may set a movement or sequence of movements for authorisation of the use of the card, such as a complex movement of the type discussed above. This may be the sole purpose of the sensed movements and/or sensed movements may also be used for changing the card between further different operating modes.

The smartcard may be any one of: an access card, a credit card, a debit card, a pre-pay card, a loyalty card, an identity card, a cryptographic card, or the like. The smartcard preferably has a width of between 85.47 mm and 85.72 mm, and a height of between 53.92 mm and 54.03 mm. The smartcard may have a thickness less than 0.84 mm, and preferably of about 0.76 mm (e.g. ±0.08 mm). More generally, the smartcard may comply with ISO 7816, which is the specification for a smartcard.

Viewed from a second aspect, the invention provides a method for controlling a smartcard, the smartcard comprising a processor for controlling operation of the smartcard and an accelerometer for sensing movements of the smartcard, wherein the method comprises detecting movements of the smartcard using the accelerometer and the processor, and switching between different modes of multiple operating modes of the smartcard in response to the detected movements.

The method may include use of a smartcard with features as discussed above in relation to the first aspect. The detected movements may be as discussed above and/or the operating modes may be as discussed above.

The method may include allowing the user to specify which movements (including combinations of movements) should activate particular operating modes.

The smartcard may comprise a biometric sensor, such as a fingerprint sensor, which is preferably embedded into the card. The method may include using the biometric sensor may be used to activate subsequent control of the card by movements, or to activate features denoted as higher security, such as a payment or withdrawal with a payment/bank card, or access to more secure areas when the smartcard is an access card.

The method may comprise authenticating the identity of a bearer of a smartcard using a biometric sensor embedded within the smartcard and enabling movement activated interaction of the user with the card only after their identity has been authenticated. The movement activated interaction with the card may be enabled for a set period after biometric authentication, for example a period of hours or days. In this way the user can access the features of the card without continued re-authentication, but with the benefit of the enhanced security provided by the use of biometrics.

The method may include the use of a sequence of movements in place of biometric authorisation, for example to allow for use of some or all operating modes of the card when biometric authorisation fails, or to allow for enrolment without using the biometric sensor.

In yet a further aspect, the present invention may also provide a computer programme product comprising instructions that, when executed on a processor in a smartcard as described above, will cause the processor to identify movements of the smartcard based on the output from the accelerometer, and to switch between different modes of multiple operating modes of the smartcard in response to the detected movements. The instructions may be arranged to cause the processor to operate in accordance with any or all of the optional and preferred features discussed above.

### BRIEF DESCRIPTION OF THE DRAWINGS

Certain preferred embodiments on the present invention will now be described in greater detail, by way of example only and with reference to the accompanying drawings, in which:

FIG. 1 illustrates a circuit for a smartcard with an accelerometer;

FIG. 2 illustrates a circuit for a smartcard also incorporating a fingerprint scanner; and

FIG. 3 illustrates an external housing for the passive smartcard incorporating the fingerprint scanner.

### DETAILED DESCRIPTION

By way of example the invention is described in the context of a card that uses contactless technology and uses power harvested from the reader. These features are envisaged to be advantageous features of the proposed movement sensitive smartcards, but are not seen as essential features. The smartcard may hence alternatively use a physical contact and/or include a battery providing internal power, for example.

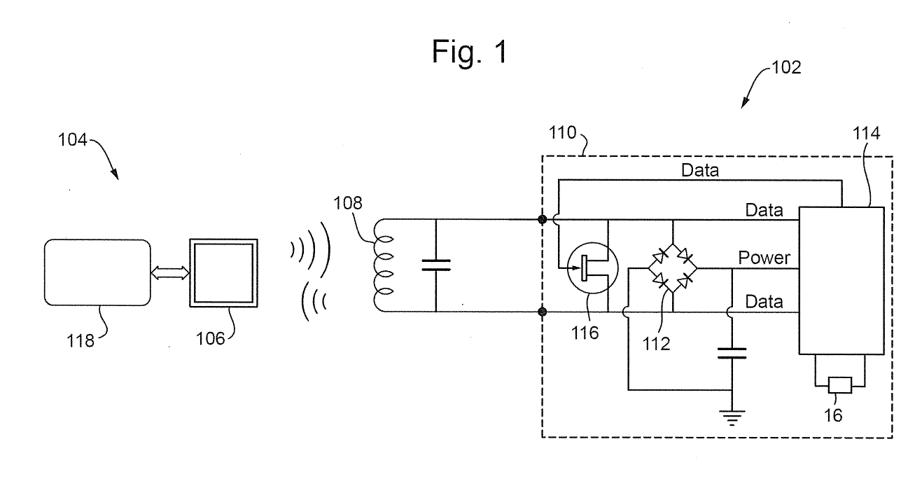

FIG. 1 shows the architecture of a smartcard 102 with the proposed accelerometer 16. A powered card reader 104 transmits a signal via an antenna 106. The signal is typically 13.56 MHz for MIFARE® and DESFire® systems, manufactured by NXP Semiconductors, but may be 125 kHz for lower frequency PROX® products, manufactured by HID Global Corp. This signal is received by an antenna 108 of the smartcard 102, comprising a tuned coil and capacitor, and then passed to a communication chip 110. The received signal is rectified by a bridge rectifier 112, and the DC output of the rectifier 112 is provided to processor 114 that controls the messaging from the communication chip 110.

A control signal output from the processor 114 controls a field effect transistor 116 that is connected across the antenna 108. By switching on and off the transistor 116, a signal can be transmitted by the smartcard 102 and decoded by suitable control circuits 118 in the reader 104. This type of signalling is known as backscatter modulation and is characterised by the fact that the reader 104 is used to power the return message to itself.

The accelerometer 16 is connected in an appropriate way to the processor 114. The accelerometer 16 can be a Tri-axis Digital Accelerometer as provided by Kionix, Inc. of Ithaca, N.Y., USA and in this example it is the Kionix KXCJB-1041 accelerometer. The accelerometer senses movements of the card and provides an output signal to the processor 114, which is arranged to detect and identify movements that are associated with required operating modes on the card as discussed below. The accelerometer 16 may be used only when power is being harvested from the powered card reader 104, or alternatively the smartcard 102 may be additionally provided with a battery (not shown in the Figures) allowing for the accelerometer 16, and also the related functionalities of the processor 114 and other features of the device to be used at any time.

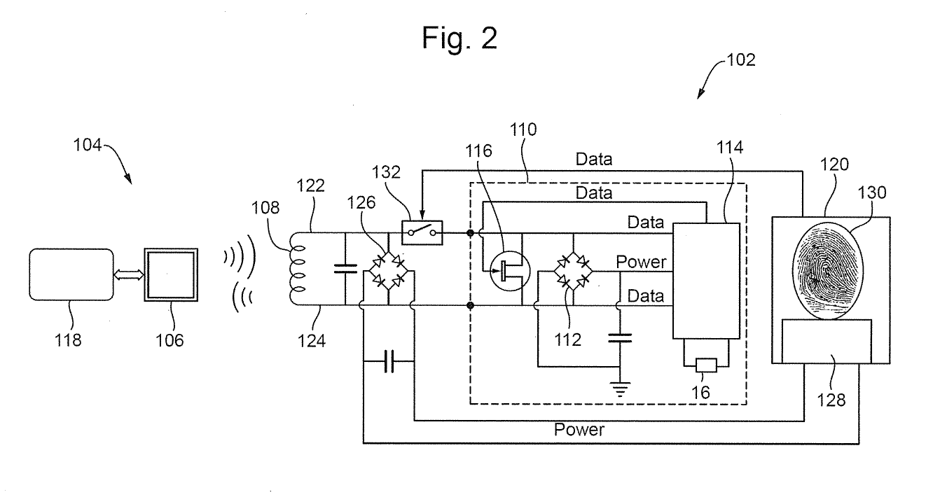

FIG. 2 shows the architecture of a card reader 104 and a passive smartcard 102, which is a variation of the passive smartcard 102 shown in FIG. 1. The smartcard 102 shown in FIG. 2 has been adapted to include a fingerprint authentication engine 120. The accelerometer 16 can be as discussed above and interacts with the processor 114 in the same way as the processor 114.

Similar to the card of FIG. 1, the smartcard 102 of FIG. 2 comprises an antenna 108 for receiving an RF (radio-frequency) signal, a passive communication chip 110 powered by the antenna 108, and a passive fingerprint authentication engine 120, also powered by the antenna 108.

As used herein, the term “passive smartcard” should be understood to mean a smartcard 102 in which the communication chip 110 is powered only by energy harvested from an excitation field, for example generated by the card reader 118. That is to say, a passive smartcard 102 relies on the reader 118 to supply its power for broadcasting. A passive smartcard 102 would not normally include a battery, although a battery may be included to power auxiliary components of the circuit (but not to broadcast); such devices are often referred to as “semi-passive devices”.

Similarly, the term “passive fingerprint/biometric authentication engine” should be understood to mean a fingerprint/biometric authentication engine that is powered only by energy harvested from an excitation field, for example the RF excitation field generated by the card reader 118.

The antenna 108 comprises a tuned circuit including an induction coil and a capacitor, which are tuned to receive an RF signal from the card reader 104. When exposed to the excitation field generated by the reader 104, a voltage is induced across the antenna 108.

The antenna 108 has first and second end output lines 122, 124, one at each end of the antenna 108. The output lines of the antenna 108 are connected to the fingerprint authentication engine 120 to provide power to the fingerprint authentication engine 120. In this arrangement, a rectifier 126 is provided to rectify the AC voltage received by the antenna 108. The rectified DC voltage is smoothed using a smoothing capacitor and supplied to the fingerprint authentication engine 120.

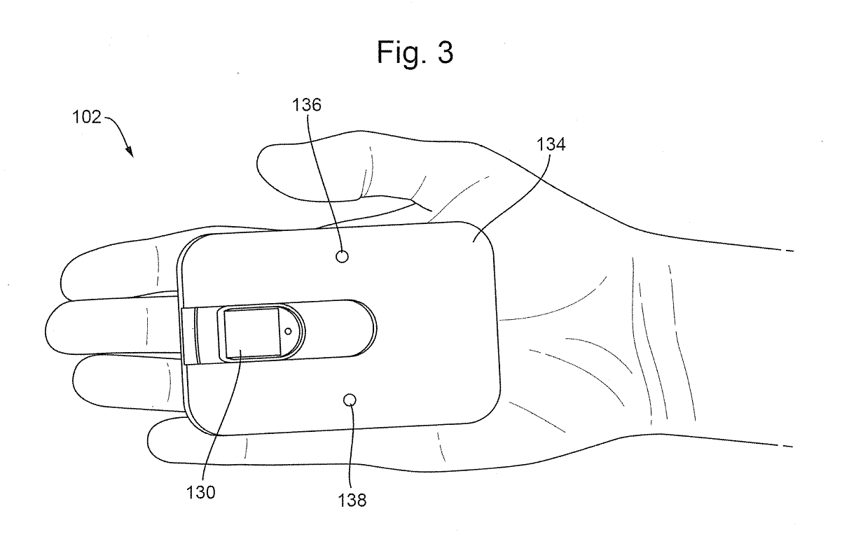

The fingerprint authentication engine 120 includes a processor 128 and a fingerprint reader 130, which can be an area fingerprint reader 130 mounted on a card housing 134 as shown in FIG. 3. The card housing 134 encases all of the components of FIG. 2, and is sized similarly to conventional smartcards. The fingerprint authentication engine 120 is passive, and hence is powered only by the voltage output from the antenna 108. The processor 128 comprises a microprocessor that is chosen to be of very low power and very high speed, so as to be able to perform biometric matching in a reasonable time.

The fingerprint authentication engine 120 is arranged to scan a finger or thumb presented to the fingerprint reader 130 and to compare the scanned fingerprint of the finger or thumb to pre-stored fingerprint data using the processor 128. A determination is then made as to whether the scanned fingerprint matches the pre-stored fingerprint data. In a preferred embodiment, the time required for capturing a fingerprint image and authenticating the bearer of the card 102 is less than one second.

With the example of FIG. 2 if a biometric match is determined and/or if appropriate movements are detected via the accelerometer 16, then the processor 114 takes appropriate action depending on its programming. In this example the fingerprint authorisation process is required to enable use of the smartcard 104 with the contactless card reader 104. Thus, the communication chip 110 is only authorised to transmit a signal to the card reader 104 when a fingerprint match is made. The communication chip 110 transmits the signal by backscatter modulation, in the same manner as the conventional communication chip 110.

For both FIG. 1 and FIG. 2 the processor 114 receives the output from the accelerometer 16 and this allows the processor 114 to determine what movements of the smartcard 102 have been made. The processor 114 identifies pre-set movements that are linked with required changes to the operating mode of the smartcard. As discussed above, the movements may include any type of or combination of rotation, translation, acceleration, jerk, impulse and other movements detectable by the accelerometer 16.

The operating modes that the processor 114 activates or switches to in response to an identified movement associated with the require change in operating mode may include any mode of operation as discussed above, including turning the card on or off, activating secure aspects of the card 102 such as contactless payment, or changing the basic functionality of the card 102 for example by switching between operating as an access card, a payment card, a transportation smartcard, switching between different accounts of the same type (e.g. two bank accounts), switching between communications protocols (such as blue tooth, wifi, NFC) and/or activating a communication protocol, activating a display such as an LCD or LED display, obtaining an output from the smartcard 102, such as a one-time-password or the like, or prompting the card 102 to automatically perform a standard operation of the smartcard 102.

The processor 114 has a learn mode to allow for the user to specify which movements (including combinations of movements) should activate particular operating modes. In the learn mode the processor 114 prompts the user to make the desired sequence of movements, and to repeat the movements for a predetermined set of times. These movements are then allocated to the required operating mode. The processor 114 can implement a dropped card mode and/or a biometric failure back up mode as discussed above.

In some circumstances, the owner of the biometric smartcard 102 of FIGS. 2 and 3 may suffer an injury resulting in damage to the finger that has been enrolled on the card 102. This damage might, for example, be a scar on the part of the finger that is being evaluated. Such damage can mean that the owner will not be authorised by the card 102 since a fingerprint match is not made. In this event the processor 114 may prompt the user for a back-up identification/authorisation check via a sequence of movements. The user can hence have a “password” entered using movements of the card to be used in the event that the biometric authorisation fails.

After such a back-up authorisation the card could be arranged to be used as normal, or it could be provided with a degraded mode in which fewer operating modes or fewer features of the cards are enabled. For example, if the smartcard 102 can act as a bank card then the back-up authorisation might allow for transactions with a maximum spending limit lower than the usual maximum limit for the card.

We claim:

1. A smartcard having multiple operating modes, the smartcard comprising a processor for controlling operation of the smartcard and an accelerometer for sensing movements of the smartcard, wherein the processor is arranged to switch between different modes of the multiple operating modes in response to the movements sensed by the accelerometer, to identify the movements of the card based on the output of the accelerometer, and to change the operating mode of the smartcard in response to pre-set movements including, one or more rotation, translation, acceleration, jerk or impulse, wherein at least one of the pre-set movements includes a repeated movement or a sequence of movements.

2. A smartcard as claimed in claim 1, wherein the processor determines the length of a time period without motion and changes the operating mode of the smartcard when a pre-set length of time without motion is detected.

3. A smartcard as claimed in claim 1, wherein the smartcard is arranged to allow the user to set their own movements and or combinations of movements and to associate them with particular changes to the operating mode of the smartcard.

4. A smartcard as claimed in claim 1, wherein the operating modes of the smartcard that are controlled by movements sensed by the accelerometer include one or more of: turning the card on or off; activating secure aspects of the card such as contactless payment; switching between operating as an access card, a payment card, and/or a transportation smartcard; or switching between different accounts of the same type.

5. A smartcard as claimed in claim 1, wherein the operating modes of the smartcard that are controlled by movements sensed by the accelerometer include one or more of: switching between communications protocols; activating a communication protocol; activating a display such as an LCD or LED display; and/or obtaining an output from the smartcard.

6. A smartcard as claimed in claim 1, wherein the operating modes of the smartcard that are controlled by movements sensed by the accelerometer includes prompting the card to automatically perform a standard operation of the smartcard.

7. A smartcard as claimed in claim 1, wherein the processor is arranged to identify when the accelerometer indicates a free fall and to place the card into a dropped card mode when free fall is detected; and wherein the dropped card mode requires reauthorisation via a security feature after the card has been picked up before further use of the card is permitted, or before full use of the card is permitted.

8. A smartcard as claimed in claim 1, wherein the accelerometer is a micro-machined accelerometer.

9. A smartcard as claimed in claim 1, wherein the acceleration sensing by the accelerometer is based on the principle of a differential capacitance arising from acceleration-induced motion of a sense element of the accelerometer.

10. A smartcard as claimed in claim 1, wherein the smartcard comprises a biometric sensor, such as a fingerprint sensor, which is embedded into the card.

11. A smartcard as claimed in claim 10, wherein a fingerprint sensor is used as the biometric sensor and wherein the smartcard is arranged to enable the authorised user to initially enroll their fingerprint onto the smartcard, and to thereafter required an enrolled finger or thumb to be placed on the fingerprint sensor in order to authorise some or all uses and/or operating modes of the card.

12. A smartcard as claimed in claim 10, wherein authorisation via the biometric sensor is required to activate subsequent control of the card by movements and/or to activate card features denoted as higher security.

13. A smartcard as claimed in claim 10, wherein in the event of a failure of biometric authorisation or failure to enroll a user via the biometric sensor then the smartcard is arranged to accept a pre-set movement as a back-up for biometric authorisation.

14. A smartcard as claimed in claim 11, wherein the pre-set movement accepted as a back-up for biometric authorisation is a complex movement taking the form of a motion sequence that includes two or more movements.

15. A smartcard as claimed in claim 11, wherein the smartcard is arranged to permit enrolment of a user using a sequence of sensed movements as the mechanism to authorise use of the card in place of biometric authorisation.

16. A method for controlling a smartcard, the smartcard comprising a processor for controlling operation of the smartcard and an accelerometer for sensing movements of the smartcard, wherein the method comprises detecting movements of the smartcard using the accelerometer and the processor, and switching between different modes of multiple operating modes of the smartcard in response to the detected movements.

17. A method as claimed in claim 16, comprising allowing the user to specify which movements should activate particular operating modes.

18. A method as claimed in claim 16, wherein the smartcard comprises a biometric sensor, such as a fingerprint sensor, and the method includes using the biometric sensor to activate subsequent control of the card by movements, or to activate features denoted as higher security.

19. A method as claimed in claim 16, wherein the smartcard includes a biometric sensor embedded within the smartcard and the method comprises using a sequence of movements in place of biometric authorisation to allow for use of some or all operating modes of the card when biometric authorisation fails and/or to allow for enrolment without using the biometric sensor.

20. A computer programme product comprising instructions that, when executed on a processor in a smartcard as claimed in claim 1, will cause the processor to identify movements of the smartcard based on the output from the accelerometer, and to switch between different modes of multiple operating modes of the smartcard in response to the detected movements.
